(19) United States
(12) Patent Application Publication
(10) Pub. No.: US 2001/0050017 A1
(43) Pub. Date: Dec. 13, 2001

(54) Ink jet printing process and printing apparatus

(75) Inventors: Sadao Ohsawa, Shizuoka (JP); Yusuke Nakazawa, Shizuoka (JP); Mutsumi Naniwa, Shizuoka (JP)

Correspondence Address: SUGHRUE, MION, ZINN, MACPEAK & SEAS, PLLC, 2100 Pennsylvania Avenue, N.W., Washington, DC, 20037, US

(73) Assignee: FUJI PHOTO FILM CO., LTD.

(21) Appl. No.: 09/852,275

(22) Filed: May 10, 2001

(30) Foreign Application Priority Data
May 11, 2000 (JP) P. 2000-138636

(51) Int. Cl. B41N 1/10

(52) U.S. Cl. 101/465

(57) ABSTRACT

Disclosed is an ink jet printing process comprising: filtering an oil-based ink; forming an image directly on a printing medium by an ink jet method comprising ejecting said filtered oil-based ink using electrostatic field based on signals of image data; and fixing said formed image to obtain a printed matter. Also disclosed is a printing apparatus suitable for the process.

### FIELD OF THE INVENTION

The present invention relates to an ink jet printing process and a printing apparatus, where a printed image is directly formed on a printing medium by an electrostatic ink jet recording using an oil-based ink and where good image quality and high-speed printing can be attained, more specifically, the present invention relates to filtering of the ink used therein.

### BACKGROUND OF THE INVENTION

The printing process for forming a printed image on a printing medium based on image data signals includes an electrophotographic method, a sublimation-type or melting-type heat-transfer method and an ink jet method.

The electrophotographic method requires a process of forming an electrostatic latent image on a photoreceptor drum through electrification and exposure and therefore, suffers from complicated system and expensive apparatus.

The heat-transfer method uses an ink ribbon and therefore, despite its inexpensive apparatus, suffers from high running cost and treatment of a waste material.

The ink jet method performs the printing directly on a printing medium by ejecting an ink only on a desired image area using an inexpensive apparatus and therefore, ensures efficient use of a coloring agent and low running cost.

With respect to the method for applying the ink jet technology to printing system, for example, JP-A-10-286939 (the term “JP-A” as used herein means an “unexamined published Japanese patent application”) discloses a process for additionally printing variable numbers, marks or the like on the same printing paper using the ink jet system by providing an ink jet printing apparatus to a rotary printing press.

The printing of image information is preferably in a level as high as comparable to the photographic image, however, conventional ink technologies of jetting out an aqueous or organic solvent-type ink containing a coloring agent of dye or pigment using a pressure is disadvantageous in that since a droplet containing a large amount of a solvent is ejected, unless expensive exclusive paper is used, blurring occurs on the printed image.

Accordingly, in the case of performing the printing on a normal printing paper, a plastic sheet as a non-absorptive medium, or the like, a high-quality printed image cannot be obtained.

As one of the ink jet technologies, a method of heat-melting an ink which is solid at an ordinary temperature, and jetting out the obtained liquid ink to form an image is known. When this ink is used, blurring of the printed image may be reduced, however, because of high viscosity of the ink at the ejection, a fine droplet cannot be jetted out and the obtained individual dot images are large in both the area and the thickness, as a result, a high-precision image cannot be formed.

In the case of drawing an image by the ink jet method, aggregates or foreign matters such as dusts in the ink fed to an ejection head which ejects the ink cause clogging of the head and this gives rise to unstable ejection of ink and in turn deterioration in the image quality or stopping of the ejection. The present invention has been made to overcome these problems.

### SUMMARY OF THE INVENTION

An object of the present invention is to provide an ink jet printing process capable of printing a printed matter having a clear and high-quality image, in which a filtering member is provided to inhibit flowing of aggregates or foreign matters such as dusts, and an ink in a normal state can be always fed to the ejection head.

Another object of the present invention is to provide a printing apparatus suitable for the printing process.

Other objects and effects of the present invention will become apparent from the following description.

The above-described objects of the present invention have been achieved by providing the following processes and apparatuses.

1) An ink jet printing process comprising:

filtering an oil-based ink;

forming an image directly on a printing medium by an ink jet method comprising ejecting said filtered oil-based ink using electrostatic field based on signals of image data; and

fixing said formed image to obtain a printed matter.

2) The ink jet printing process according to item 1) above, wherein said oil-based ink comprises:

a nonaqueous solvent having an electric resistivity of 10⁹ Ωcm or more and a dielectric constant of 3.5 or less; and

a component dispersed in said nonaqueous solvent, which comprises at least colored particles.

3) A printing apparatus comprising:

image-forming unit which directly forms an image on a printing medium based on signals of image data; and

image-fixing unit which fixes the formed image to obtain a printed matter,

wherein said image-forming unit comprises an ink jet drawing device which ejects an oil-based ink from an ejection head using electrostatic field and which has at least one ink-filtering member provided in an ink passage.

4) The printing apparatus according to item 3) above, wherein said filtering member is provided at a portion immediately preceding an ink ejection part of said ejection head.

5) The printing apparatus according to item 3) or 4) above, wherein said filtering member comprises a filter material which blocks coarse aggregates of said ink and foreign matters including dust mingled during the drawing.

6) The printing apparatus according to item 5) above, wherein said filter material has pores having various shapes and sizes, each of said pores having a minimum pore distance of not less than 2 μm.

7) The printing apparatus according to item 5) or 6) above, wherein said filter material has a single-layer or multilayer structure.

8) The printing apparatus according to item 7) above, wherein said multilayer filter material comprises filter material layers including: a coarsest protective body and a coarsest support provided in an upstream side and a downstream side, respectively; and filter material layers provided between said protective body and support in such a manner that the pore sizes of the layers are sequentially reduced toward the downstream side.

9) The printing apparatus according to any one of items 5) to 8) above, wherein said filter material has at least one figuration selected from the group consisting of single plate form, tea strainer form, coming back form and cylinder form.

10) The printing apparatus according to any one of items 5) to 9) above, wherein said filter material comprises as least one material selected from the group consisting of paper, plastic, metal, ceramic and glass.

11) The printing apparatus according to any one of items 5) to 10) above, wherein said filter material is of cartridge-type and exchangeable.

12) The printing apparatus according to any one of items 5) to 11) above, further comprising a filter material accumulation-removing member which removes substances accumulated on said filter material.

13) The printing apparatus according to item 12) above, wherein said removal of the filter material accumulation is performed by at least one means of ultrasonic irradiation, vibration and back flow of said ink or a cleaning solution.

14) The printing apparatus according to item 13) above, wherein said filtering member comprises at least one filtering systems selected from gravity filtration, pressure filtration, vacuum filtration and constant rate filtration.

15) The printing apparatus according to any one of items 3) to 14) above, wherein said oil-based ink comprises:

a nonaqueous solvent having an electric resistivity of 10⁹ Ωcm or more and a dielectric constant of 3.5 or less; and

a component dispersed in said nonaqueous solvent, which comprises at least colored particles.

16) The printing apparatus according to any one of items 3) to 15) above, further comprising a dust-removing member which removes dusts present on the surface of said printing medium at least one of before and during the printing onto said printing medium.

17) The printing apparatus according to any one of items 3) to 16) above, further comprising an opposing drum for mounting said printing medium disposed at a position facing said ejection head, said opposing drum being rotatable so as to move said printing medium to perform said image formation.

18) The printing apparatus according to item 17) above, wherein said ejection head comprises a single channel head or a multi-channel head and is movable in a direction parallel to the axis of said opposing drum to perform said image formation.

19) The printing apparatus according to any one of items 3) to 16) above, further comprising at least a pair of capstan rollers for running said printing medium while being interposed and held therebetween upon said image formation.

20) The printing apparatus according to item 19) above, wherein said ejection head comprises a single channel head or a multi-channel head and is movable in a direction orthogonal to the running direction of said printing medium to perform said image formation.

21) The printing apparatus according to item 17) or 19) above, wherein said ejection head comprises a full line head having almost the same length as the width of said printing medium.

22) The printing apparatus according to any one of items 3) to 21) above, wherein said ink jet drawing device has an ink feed member which feeds said oil-based ink to said ejection head.

23) The printing apparatus according to item 22) above, further comprising an ink recovery member which recovers said oil-based ink from said ejection head to circulate the ink.

24) The printing apparatus according to any one of items 3) to 23) above, wherein said ink jet drawing device has an ink tank for storing said oil-based ink and a stirring member which stirs the oil-based ink in said ink tank.

25) The printing apparatus according to any one of items 3) to 24) above, wherein said ink jet drawing device has an ink temperature-controlling member which controls the temperature of said oil-based ink in an ink tank for storing said oil-based ink.

26) The printing apparatus according to any one of items 3) to 25) above, wherein said ink jet drawing device has an ink concentration-controlling member which controls the concentration of said oil-based ink.

27) The printing apparatus according to any one of items 3) to 26) above, which comprises an ejection head-cleaning member.

According to the construction of item 1) above, the oil-based ink is filtered before use, so that foreign matters in the ink can be prevented from flowing into the ejection head and stable ejection can be performed.

According to the construction of item 3) above, a filter for ink is inserted between the ink tank and the ejection head, so that foreign matters in the ink can be inhibited from flowing into the ejection head and generation of unstable ejection can be prevented.

According to the construction of item 4) above, a filter is disposed in particular immediately before the ejection head, so that a clean ink right after filtering can be fed to the ejection head.

According to the construction of item 5) above, aggregated ink particles or foreign matters mingled on the way, such as dust, are filtered through a filter to feed a normal ink to the ejection head, so that unstable ejection due to clogging of the ejection head can be prevented and therefore, change in the dot size during the drawing or deterioration of the image such as slipping or thinning, which are ascribable to unstable ejection can be prevented.

According to the construction of item 6) above, pores different in the shape and in the size are allowed to be present together, so that effective filtering can be attained for foreign matters having various shapes and sizes and the ink can be filtered without causing any reduction in the filtering rate.

According to the construction of item 7) above, the filter has a single-layer or multilayer structure, so that the filter can be properly used according to the purpose, for example, a single-layer (for example, single plate-type) filter is used in the case where the ink has good quality and the filtering rate is important as in the disposition immediately before the recording heat, whereas a multilayer-type filter ensuring high filtering power, scarce clogging and use for a long period of time is disposed in the pump side because a pump pressure or the like is necessary so as not to reduce the filtering rate.

According to the construction of item 8) above, a filter having a coarse pore size is disposed in the ink inflow side to roughly filter the ink and remove main foreign matters, and a dense filter is disposed thereon as a next stage to completely remove foreign matters, so that filtration can be effectively performed over a long period of time without causing reduction in the filtering rate.

According to the construction of item 9) above, the shape of the filter can be selected from various forms such as simple single-plate form, inline-type tea caddy form capable of taking out and cleaning or exchanging only a filter element on the way, coming back form of performing circulation filtering through the filtering layer divided into many layers, and cylinder form including multilayer type and hollow yarn type, by taking account of the quality or volume of ink or conditions such as place for installation or construction or performance of the apparatus.

According to the construction of item 10) above, a filter comprising a construction material selected from materials over a wide range can be used by taking account of the use end, such as paper for usage having high frequency of exchange or disposal, membrane-type plastic (polymer) material obtained by bundling many hollow plastic yarns to have a cross section of hollow yarn-type filter like a hollow yarn film, metal of wire-mesh type or obtained by stacking and sintering of stainless steel metal fiber felts and capable of long-term use when washed or cleaned, glass and ceramic.

According to the construction of item 11) above, a hollow yarn-type or multilayer cylinder-type filter for use in a water purifier or the like can be exchanged together with the cartridge housing the filter by a simple and quick operation and in the case of a tea caddy-type (T-type inline) filter, only the element itself can be taken out and returned after cleaning or exchanged while allowing the filter to remain on the line.

According to this construction of item 12) above, means for cleaning the filter material is provided, so that cleaning and removal can be performed automatically or appropriately by hand at a predetermining timing (for example, every 300 hours of operating).

According to the construction of item 13) above, the accumulation can be removed by means of ultrasonic irradiation or vibration applied to the filter and in addition, by a method of back-flowing the ink or cleaning solution. In the case of a hollow yarn-type filter, efficient cleaning can be attained by the back flow from the water outlet side to the water inlet side.

According to the construction of item 14) above, the filtration is performed by flowing the ink under a pressure resultant from combining gravity filtration using a gravity of the ink itself, pressure filtration using a pump pressure and vacuum filtration using a vacuum pump pressure, so that the filtration can be efficiently performed without causing any reduction in the filtering rate (ink flow rate). The pressure may be a pump pressure of the ink feed part, circulation part, tank or the like.

### BRIEF DESCRIPTION OF THE DRAWINGS

FIG. 1 is a view schematically showing a construction example of a drawing device in an ink jet printing apparatus of the present invention, including a control part, an ink feed part and a head-retreating or approximating mechanism of the drawing device.

FIG. 2 is a construction view of a device where an ink circulating function is imparted to the ink feed device of FIG. 1.

FIG. 3 is a perspective view showing one specific example of the ejection head of FIG. 1.

FIG. 4 is an enlarge cross-sectional view for explaining the ink jet drawing device of FIG. 3.

FIG. 5 is a schematic cross-sectional view showing the vicinity of the ink ejection part of the ejection head according to another example.

FIG. 6 is a schematic front view showing the vicinity of the ink ejection part of the ejection head of FIG. 5.

FIG. 7 is a schematic view showing only one part of the ejection head according to another example.

FIG. 8 is a schematic view of the ejection head of FIG. 7 from which regulating plates 42 and 42′ are removed.

FIG. 9 is a schematic view showing one part of the ejection head in another example having a pair of nearly rectangular plate-like support members.

FIGS. 10(a) and 10(b) are explanatory views of pores of filters.

FIG. 11 is a perspective view of a multilayer-type filter.

FIG. 12 is a cross-sectional view of a single plate-type filter.

FIG. 13 is a cross-sectional view of a tea strainer-type filter.

FIG. 14 is an explanatory view of a coming back-type filter.

FIG. 15 is an entire construction view schematically showing a web-type apparatus for performing one-side monochromatic printing, which is one example of the ink jet printing apparatus of the present invention.

FIG. 16 is an entire construction view schematically showing a web-type apparatus for performing one-side four-color printing, which is another example of the ink jet printing apparatus of the present invention.

FIG. 17 is an entire construction view schematically showing a two-side four-color printing apparatus, which is another example of the ink jet printing apparatus of the present invention.

FIG. 18 is an entire construction view schematically showing a two-side four-color printing apparatus, which is another example of the ink jet printing apparatus of the present invention.

FIG. 19 is an entire construction view schematically showing a one-side four-color printing apparatus for performing the printing by cutting a rolled printing medium and winding it around an opposing drum, which is another example of the ink jet printing apparatus of the present invention.

FIG. 20 is an entire construction view schematically showing a printing apparatus using a sheet-like recording medium, which is another example of the ink jet printing apparatus of the present invention.

FIG. 21 is an entire construction view schematically showing a printing apparatus for performing the drawing by running a rolled printing medium while interposing and holding it between capstan rollers, which is another example of the ink jet printing apparatus of the present invention.

FIG. 22 is an entire construction view schematically showing a printing apparatus for performing the drawing by running a sheet-like recording medium while interposing and holding it between capstan rollers, which is another example of the ink jet printing apparatus of the present invention.

### DETAILED DESCRIPTION OF THE INVENTION

The present invention is described in detail below.

The present invention is characterized in that at the formation of an image by an ink jet method of ejecting an oil-based ink using an electrostatic field to a printing medium fed to a printing apparatus, the oil-based ink is filtered.

The ink jet method according to the present invention is described in PCT Publication WO93/11866. In this ink jet method, an ink having high resistance obtained by dispersing at least colored particles in an insulating solvent is used, a strong electric field is allowed to act on this ink at the ejection position to form an aggregate of the colored particles at the ejection position, and the aggregate is ejected from the ejection position using electrostatic means. In this way, the colored particles are ejected as an aggregate formed to a high concentration and the ink droplet contains only a small amount of solvent, as a result, a high-density clear image free of blurring is formed on a printing paper or a plastic film for printing used as a recording medium.

In this ink jet method, the size of the ink droplet ejected is determined by the size of the distal end of the ejecting electrode or the conditions in forming the electric field. Therefore, when a small ejection electrode and appropriate electric field-forming conditions are used, a small ink droplet can be obtained without reducing the ejection nozzle size or slit width.

In other words, the present invention provides an ink jet printing process where a fine image can be controlled without causing any problem of ink clogging in the head and a printed matter having a clear and high-quality image can be printed.

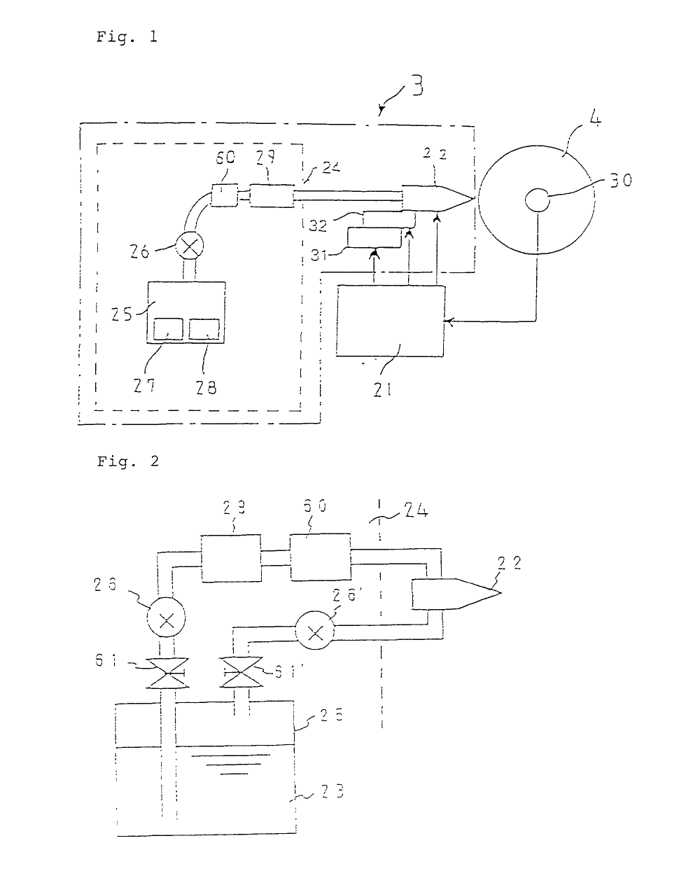

The ink jet drawing device according to the present invention is described in detail by referring to FIG. 1.

FIG. 1 is a view schematically showing a construction example of the ink jet drawing device including a control part, an ink feed part and a head-retreating or approximating mechanism of the drawing device.

As shown in FIG. 1, the ink jet drawing device 3 for use in the ink jet printing process of the present invention comprises an ejection head 22 and an ink feed part 24.

The ink feed part 24 further comprises an ink tank 25, an ink feed device 26, a filter 60 as ink-filtering member (described later) and ink concentration-controlling member 29 and in the ink tank, stirring member 27 and ink temperature-controlling member 28 are contained. The ink may be circulated within the head as shown in FIG. 2 (described later) and in this case, the ink feed part additionally has a recovery and circulating function. The stirring member 27 prevents the precipitation and coagulation of solid contents in the ink. For the stirring member, a rotary blade, an ultrasonic vibrator and a circulating pump may be used and these are used individually or in combination. The ink temperature-controlling member 28 is disposed so that the physical properties of ink or the dot size can be prevented from varying by the change of the ambient temperature and a high-quality image can be stably formed. For the ink temperature-controlling member, a known method may be used, for example, a method where a heat-generating element or a cooling element such as heater or Peltier device is disposed within the ink tank together with the stirring member and the temperature distribution within the tank is controlled constant by a temperature sensor such as thermostat. The ink temperature within the ink tank is preferably from 15 to 60° C., more preferably from 20 to 50° C. The stirring member which maintains the temperature distribution within the tank to be constant may share the stirring member for the purpose of preventing the precipitation or coagulation of solid components in ink.

FIG. 2 is a construction view of an ink feed device 24 having an ink recovery function. As shown in the figure, the ink feed device 24 has a valve 61, a pump 26 for feeding ink to the ejection head 22, ink concentration-controlling member 29 and filtering member 60 and additionally has, for circulating and recovering ink from the head, a circulation recovery pump 26′ and a valve 61′. In FIG. 2, the filter 60 is disposed immediately before a recording ejection head 22 and therefore, a more clean ink can be fed to the recording ejection head 22.

This ink jet drawing device has ink concentration-controlling member 29 for achieving high-quality drawing. The ink concentration is controlled by measuring the physical properties using, for example, optical detection, measurement of electrical conductivity or measurement of viscosity, or by counting the number of sheets subjected to the drawing. In the case of controlling the ink concentration by measuring the physical properties, an optical detector, an electrical conductivity-measuring meter and a viscosity-measuring meter are provided individually or in combination within the ink tank or on the ink flowing passage and according to the output signal thereof, the feed to the ink tank from a concentrated ink tank (not shown) for replenishment or from a diluting ink carrier tank is controlled. In the case of controlling the ink concentration by counting the number of sheets subjected to the drawing, the feed is controlled by the number of sheets printed and the frequency of printing.

21 is an image data arithmetic and control part. The image data arithmetic and control part 21 computes the input image data or takes in the timing pulse from a head-retreating or approximating device 31 or an encoder 30 disposed in the opposing drum or capstan roller and drives the head according to the timing pulse. At the time of performing the drawing by the ink jet drawing device, the opposing drum 4 is driven using high-precision driving means. To speak specifically, for example, a method of driving the drawing drum while decelerating the output from a high-precision motor using a high-precision gear or steel belt may be used. By using these means individually or in combination, higher-quality drawing can be attained.

As such, the image data arithmetic and control part 21 receives image data from an image scanner, a magnetic disc device, an image data transmission device or the like, performs color separation, then partitions and computes the separated data into an appropriate number of picture elements or an appropriate number of gradations, and shares the results to respective heads. Furthermore, since the oil-based ink image is drawn as a dotted image using the ink jet ejection head 22 of the ink jet drawing device 3, the halftone dot area ratio is also computed.

In the image data arithmetic and control part 21, the movement of the ink jet ejection head 22 and the timing of ejecting the oil-based ink are controlled and if desired, the timing of operating the printing medium is also controlled. More specifically, the image data from a magnetic disc device or the like is given to the image data arithmetic and control part 21 and according to the input image data, the image data arithmetic and control part 21 computes the position of ejecting an oil-based ink and the halftone dot area ratio at that position. These computed data are once stored in a buffer. The image data arithmetic and control part 21 approximates the ejection head 22 to the position proximate to printing medium contacting with the drawing drum using a head-retreating or approximating device 31. The ejection head 22 and the surface of a printing medium are kept at a predetermined distance during the drawing using mechanical distance controlling member such as knock roller or under the control of the head-retreating or approximating device based on the signals from an optical distance detector. For the ejection head 22, a single channel head, a multi-channel head or a full line head may be used.

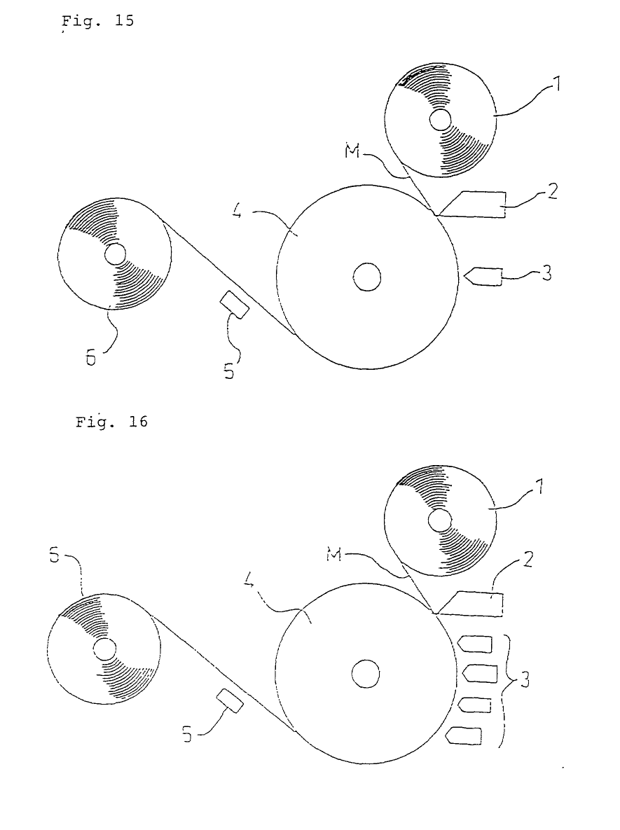

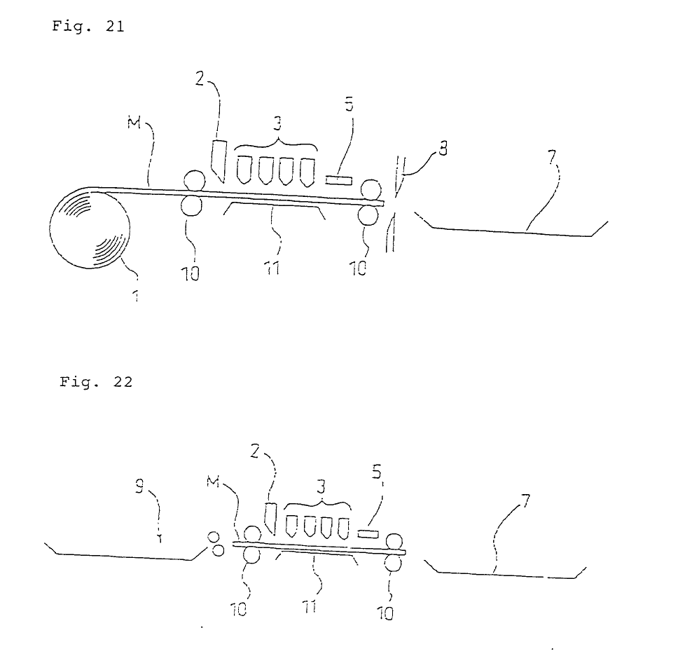

In the case where a single channel head or a multi-channel head is used as the ejection head and where a printing medium web is used (as shown in FIGS. 15 to 18) or a printing medium is transported by capstan rollers (as shown in FIGS. 21 and 22), the head is disposed such that the ejection parts are arrayed in almost parallel to the traveling direction of the printing medium, and printing is performed while performing the main scanning by the movement of ejection head in the direction parallel to the axis of the opposing drum and performing the sub-scanning by the rotation of the opposing drum. The movements of the drawing drum and the ejection head as described above are controlled by the image data arithmetic and control part 21 and the ejection head ejects an oil-based ink on the printing medium based on the ejection position and the halftone dot area ratio obtained by the computation. By this, a halftone image is drawn by the oil-based ink according to the variable density of the printing original. This operation continues until a predetermined ink image is formed on the printing drum.

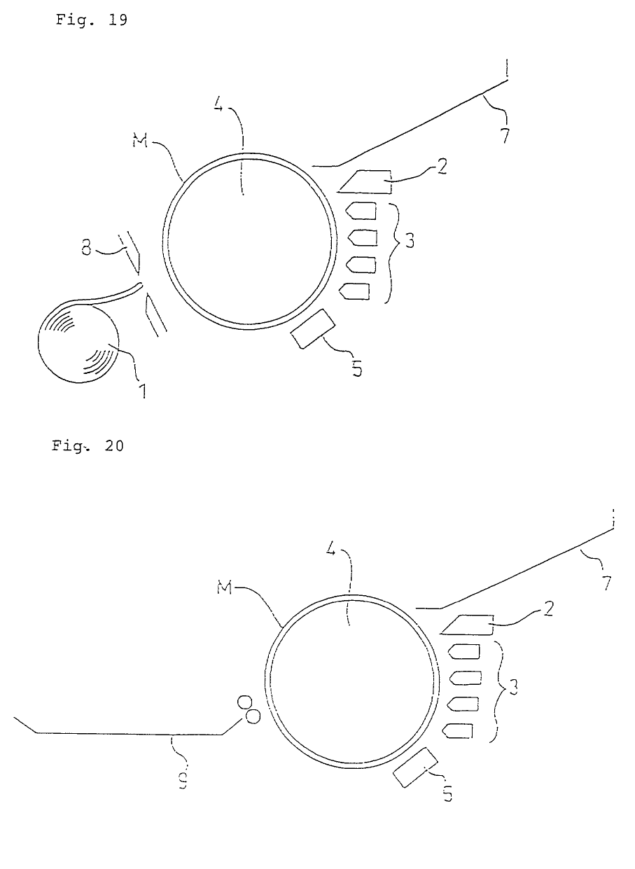

In the case where a single channel head or a multi-channel head is used as the ejection head and where a rolled printing medium is wound around an opposing drum (as shown in FIGS. 19 and 20), the head is disposed such that the ejection parts are arrayed in the direction substantially parallel to the axis of the drum, and printing is performed while performing main scanning by the rotation of the drum and performing sub-scanning by the movement of the ejection head in the direction parallel to the axis of the drum.

On the other hand, in the case where the ejection head 22 is a full line head having almost the same length as the width of the drum, the head is disposed to array the ejection parts at a right angle to the traveling direction of the printing medium and an oil-based ink image is formed by rotating the opposing drum and thereby passing the surface of the opposing drum through the drawing part and obtaining a printed matter.

After the completion of image formation, if desired, the ejection head 22 is retreated to come apart from the position proximate to the drawing drum so as to protect the ejection head 22. At this time, only the ejection head 22 may be retreated or approximated but the ejection head 22 and the ink feed part 24 may be retreated or approximated together.

This retreating or approximating means 31 is operated to separate the ejection head at least 500 μm or more apart from the drawing drum 4 except for the drawing time. The retreating/approximating operation may be performed by a slide system or by a pendulum system of fixing the head using an arm fixed to a certain axis and moving the arm around the axis. By retreating the ejection head at the non-drawing time, the ejection head can be protected from the physical breakage or contamination and can have a long life.

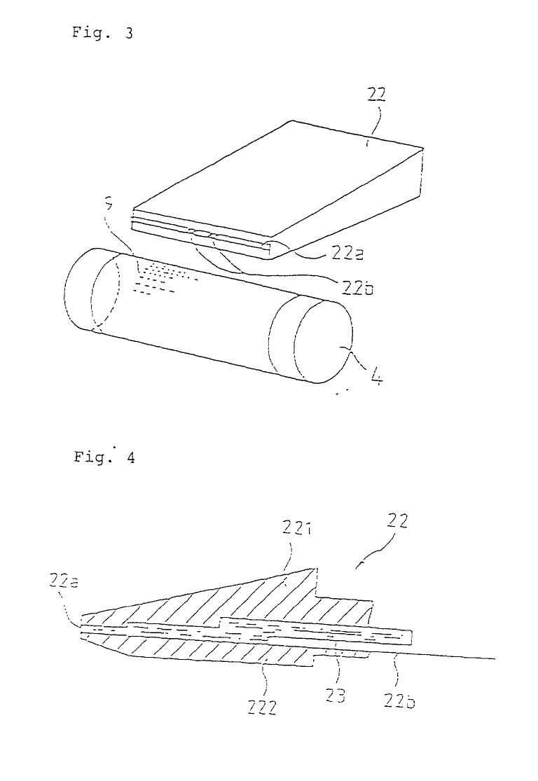

The ejection head 22 is described below using FIGS. 3 to 9. FIGS. 3 to 9 each is a view for describing the ejection head 22 provided in the ink jet drawing device of FIG. 1, however, the present invention is not limited to the following example.

FIGS. 3 and 4 each is a view showing one example of the head provided in the ink jet drawing device. The ejection head 22 has a slit between an upper unit 221 and a lower unit 222 each comprising an insulating substrate, and the distal end of the slit works out to an ejection slit 22a. Within the slit, an ejection electrode 22b is disposed and the slit is filled with an ink 23 fed from the ink feed device. Examples of the insulating substrate which can be used include plastics, glass and ceramics. The ejection electrode 22b is formed by a known method, for example, a method of subjecting the lower unit 222 comprising an insulating substrate to vapor deposition, sputtering or electroless plating with an electrically conductive material such as aluminum, nickel, chromium, gold and platinum, coating a photoresist thereon, exposing the photoresist through a predetermined electrode pattern mask, developing it to form a photoresist pattern of the ejection electrode 22b and etching the pattern, a method of mechanically removing the photoresist pattern or a method comprising a combination thereof.

In the ejection head 22, a voltage is applied to the ejection electrode 22b according to digital signals of the image pattern information. As shown in FIG. 3, a drawing drum which works out to a counter electrode is provided to oppose the ejection electrode 22b and on the drawing drum, a printing medium is provided. By the application of a voltage, a circuit is formed between the ejection electrode 22b and the drawing drum as a counter electrode and an oil-based ink 23 is ejected from the ejection slit 22a of the ejection head 22 to form an image on the printing medium provided on the drawing drum which works out to a counter electrode.

With respect to the width of the ejection electrode 22b, the tip thereof is preferably as narrow as possible to form a high-quality image. The specific numerical value varies according to the conditions such as applied voltage and physical properties of ink but the tip width is usually from 5 to 100 μm.

For example, a dot of 40 μm can be formed on the printing medium 9 by using an ejection electrode 22b having a tip in the width of 20 μm, providing a distance of 1.0 mm between the ejection electrode 22b and the drawing drum 4 working out to a counter electrode, and applying a voltage of 3 KV between these electrodes for 0.1 msec.

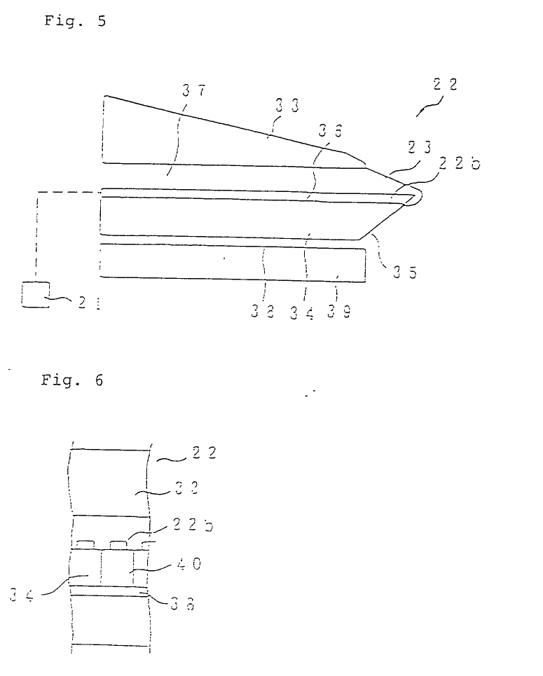

FIGS. 5 and 6 are a schematic cross-section view and a schematic front view, respectively, showing the vicinity of the ink ejection part in another example of the ejection head. In the Figures, 22 is an ejection head and this ejection head 22 has a first insulating substrate 33 having a tapered shape. Opposing the first insulating substrate 33, a second insulating substrate 34 is provided with a clearance and at the distal end of the second insulating member 34, an inclined face part 35 is formed. The first and second insulating substrates each is formed of, for example, plastic, glass or ceramic. On the upper face part 36 making an acute angle with respect to the inclined face part 35 of the second insulating substrate 34, a plurality of ejection electrodes 22b are provided as means for forming an electrostatic field on the ejection part. Respective tips of these multiple ejection electrodes 22b are extended to the vicinity of the distal end of the upper face part 36 and the tips each is projected ahead of the first insulating substrate 33 and forms an ejection part. Between the first and second insulating substrates 33 and 34, an ink inflow passage 37 is formed as means for feeding an ink 23 to the ejection part and in the lower side of the second insulating substrate 34, an ink recovery passage 38 is formed. The ejection electrode 22b is formed on the second insulating substrate 34 similarly to the above by a known method using an electrically conducting material such as aluminum, nickel, chromium, gold and platinum. The individual electrodes 22b are constructed to lie in the electrically insulating state from each other. The tip of the ejection electrode 22b is preferably projected to the length of 2 mm or less from the distal end of the insulating substrate 33. The projection length is preferably within this range because if the projection length is excessively large, the ink meniscus does not reach the tip of the ejection part and the ink becomes difficult to jet out or the recording frequency decreases. The space between the first and second insulating substrates 33 and 34 is preferably from 0.1 to 3 mm. The space is preferably within this range because if the space is too small, the feeding and in turn ejection of the ink become difficult or the recording frequency decreases, whereas if the space is excessively large, the meniscus is not stabilized and unstable ejection is caused. The ejection electrode 22b is connected to the image data arithmetic and control part 21 and in performing the recording, a voltage is applied to the ejection electrode based on the image information, the ink on the ejection electrode is ejected and an image is drawn on a printing medium (not shown) disposed to oppose the ejection part. In the direction reverse to the ink droplet-ejecting direction of the ink inflow passage 37, ink feed member of the ink feed device (not shown) is connected. On the surface opposite the ejection electrode-formed surface of the second insulating substrate 34, a backing 39 is provided to oppose the ejection electrode with a clearance. Between these surfaces, an ink recovery passage 38 is provided. The ink recovery passage 38 preferably has a space of 0.1 mm or more. The space is limited to this range because if the space is too small, the recovery of ink becomes difficult and ink leakage may occur. To the ink recovery passage 38, ink recovery member (not shown) of the ink feed device is connected. In the case where a uniform ink flow is necessary on the ejection part, a groove 40 may be provided between the ejection part and the ink recovery part. FIG. 6 is a schematic front view showing the vicinity of the ink ejection part of the ejection head. On the inclined face of the second insulating substrate 34, a plurality of grooves 40 are provided to extend from the vicinity of the boundary with the ejection electrode 22b toward the ink recovery passage 38. These grooves 40 in plurality are aligned in the array direction of the ejection electrodes 22b and each has a function of introducing a constant amount of ink in the vicinity of the tip of the ejection electrode through the opening in the ejection electrode 22b side by a capillary force according to the opening diameter and discharging the introduced ink to the ink recovery passage 38 and therefore, has a function of forming an ink flow having a constant liquid thickness in the vicinity of the ejection electrode tip. The shape of the groove 40 may be sufficient if the capillary force can work, but the width is preferably from 10 to 200 μm and the depth is preferably from 10 to 300 μm. The grooves 40 are provided in the number necessary for forming a uniform ink flow throughout the head.

With respect to the width of the ejection electrode 22b, the tip of the ejection electrode is preferably as narrow as possible for forming a high-quality image. The specific numerical value varies depending on the applied voltage, physical properties of ink or the like, however, the tip width is usually from 5 to 100 μm.

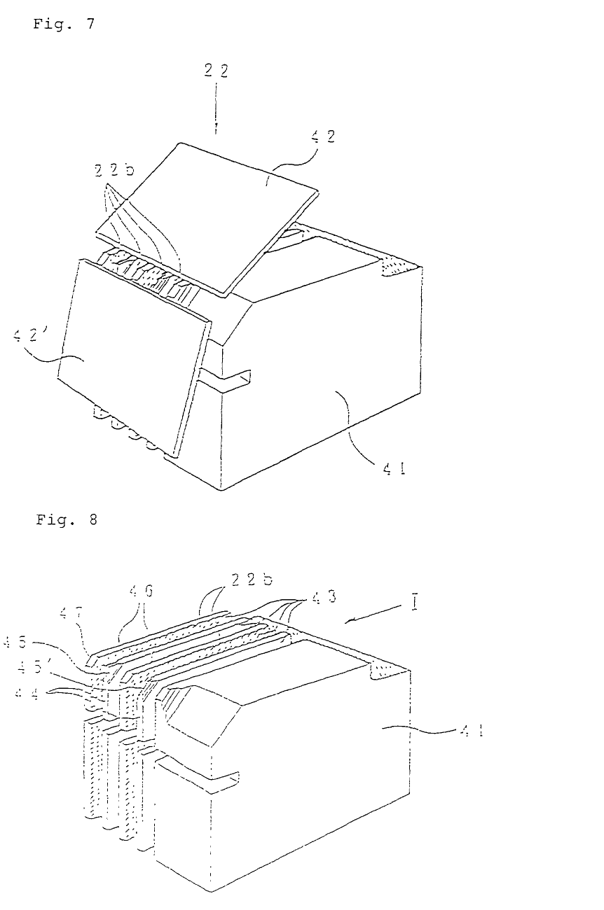

FIGS. 7 and 8 each is a view showing another example of the ejection head used for practicing the present invention. FIG. 7 is a schematic view showing only a part of the head for the purpose of explanation. As shown in FIG. 7, the recording ejection head 22 comprises a head body 41 formed of an insulating material such as plastic, ceramic or glass, and meniscus regulating plates 42 and 42′. In the Figures, 22b is an ejection electrode for applying a voltage and thereby forming an electrostatic field in the ejection part. The head body is described in detail below by referring to FIG. 8 showing the head exclusive of the meniscus regulating plates 42 and 42′. In the head body 41, a plurality of ink grooves 43 for circulating the ink are provided perpendicularly to the edge of the head body. The shape of the ink groove 43 may be sufficient if the capillary force can work and thereby a uniform ink flow can be formed, but the width of the ink groove is preferably from 10 to 200 μm and the depth is preferably from 10 to 300 μm. Inside the ink groove 43, an ejection electrode 22b is provided. This ejection electrode 22b may be provided throughout or only on a part of the inner surface of the ink groove 43 of the head body 41 comprising an insulating material, using an electrically conducting material such as aluminum, nickel, chromium, gold and platinum by a known method similarly to the case of the above-described apparatus example. The ejection electrodes are electrically isolated from each other. One cell is formed by two adjacent ink grooves and in the center thereof, a partition 44 is disposed. At the distal end of the partition 44, ejection parts 45, 45′ are provided. The partition is reduced in the thickness and sharpened at the ejection parts 45, 45′ as compared with other partition parts 44. Such a head body is manufactured using an insulating material block by a known method such as mechanical working, etching or molding. The thickness of the partition at the ejection part is preferably from 5 to 100 μm and the radius of curvature at the sharpened tip is preferably from 5 to 50 μm. The ejection part may be slightly chamfered as shown by 45′. In the Figures where only two cells are shown, the cells are divided by a partition 46 and the distal end 47 thereof is chambered to recede than the ejection parts 45, 45′. Into this head, an ink is flown through the ink groove from the I direction by the ink feed member of the ink feed device (not shown) to feed the ink to the ejection part. The excess ink is recovered toward the O direction by ink recovery member (not shown), whereby a fresh ink is always fed to the ejection part. In this state, a voltage is applied to the ejection electrodes according to the image information, as a result, an ink is ejected from the ejection parts to a drawing drum (opposing drum) (not shown) provided to oppose the ejection part and having abutted to the surface thereof a printing medium, whereby an image is formed on the printing medium.

FIG. 9 shows still another example of the ejection head. As shown in FIG. 9, the ejection head 22 has a pair of support members 50 and 50′ nearly in the rectangular plate shape. These support members 50 and 50′ are formed of a plate-like material having an insulating property, such as plastic, glass or ceramic, and having a thickness of 1 to 10 mm. On one surface of each support member, a plurality of rectangular grooves 51, 51′ extending in parallel to each other are formed according to the recording resolution. Each groove 51, 51′ preferably has a width of 10 to 200 μm and a depth of 10 to 300 μm. Throughout or on a part of the inside thereof, an ejection electrode 22b is formed. By forming a plurality of grooves 51, 51′ on one surface of each support 50, 50′ as such, a plurality of rectangular partitions 52 are necessarily formed between respective grooves 51. The respective support members 50 and 50′ are combined such that the surfaces having not provided thereon the grooves 51, 51′ face each other. Namely, the ejection head 22 has a plurality of grooves for passing an ink on the outer peripheral surfaces. The grooves 51 and 51′ formed on respective support members 50 and 50′ are connected through the rectangular part 54 of the ejection head 22 to correspond to one another. The rectangular parts 54 resultant from respective grooves being connected are each retreated by a predetermined distance (from 50 to 500 μm) from the upper end 53 of the ejection head 22. In other words, the upper end 55 of each partition 52 in both sides of each rectangular part 54 of respective support members 50 and 50′ projects from the rectangular part 54. On each rectangular part 54, a guide projection 56 comprising an insulating material described above is provided to project therefrom and forms an ejection part. In the case of circulating an ink to the thus-constructed ejection head 22, an ink is fed to each rectangular part 54 through each groove 51 formed on the outer peripheral surface of one support member 50 and discharged through each groove 51′ formed on the support member 50′ in the opposite side. In this case, the ejection head 22 is inclined at a predetermined angle so as to enable smooth flow of the ink. That is, the ejection head 22 is inclined such that the ink feed side (support member 50) is positioned upward and the ink discharge side (support member 50′) is positioned downward. When an ink is circulated to the ejection head 22 as such, the ink passing through each rectangular part 54 comes to full wetting along each projection 56, and an ink meniscus is formed in the vicinity of the rectangular part 54 and the projection 56. In this state where ink meniscuses are formed independently from each other on respective rectangular parts 54, a voltage is applied to the ejection electrode 22b based on the image information, as a result, an ink is ejected from the ejection part toward a drawing drum (not shown) provided to oppose the ejection part and having abutted to the surface thereof a printing medium and an image is formed on the drawing drum. Here, a cover for covering the grooves may be provided on the outer peripheral surface of each support member 50, 50′ to form a piped ink passage on the outer peripheral surface of each support member 50, 50′ and thereby forcedly circulate the ink through this ink passage. In this case, the ejection head 22 needs not be inclined.

The ejection head 22 shown in FIGS. 3 to 9 may contain a maintenance device such as head cleaning member, if desired. For example, in the case where the dormant state continues or where a trouble is generated in the image quality, means for wiping off the ejection head tip with a material having flexibility, such as scrub, brush or cloth, means for circulating only an ink solvent, means for feeding only an ink solvent, and means for suctioning the ejection part while circulating the ink solvent may be used. By using these means individually or in combination, a good drawing state can be maintained. For preventing the solidification of the ink, a method of placing the ejection head within a cover filled with ink solvent vapor, or a method of cooling the head part to suppress the evaporation of the ink solvent is also effective. In the case where the contamination is more sticking, a method of enforcedly suctioning the ink from the ejection part, a method of enforcedly flowing an air, ink or ink solvent jet from the ink passage, or a method of applying an ultrasonic wave while dipping the head in an ink solvent is effective. These methods may be used individually or in combination.

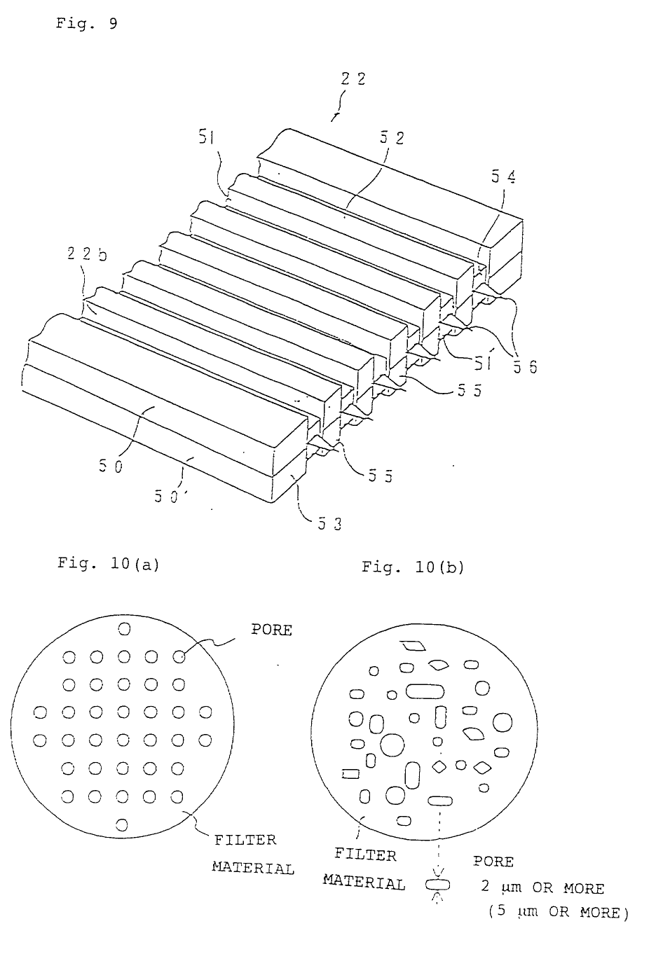

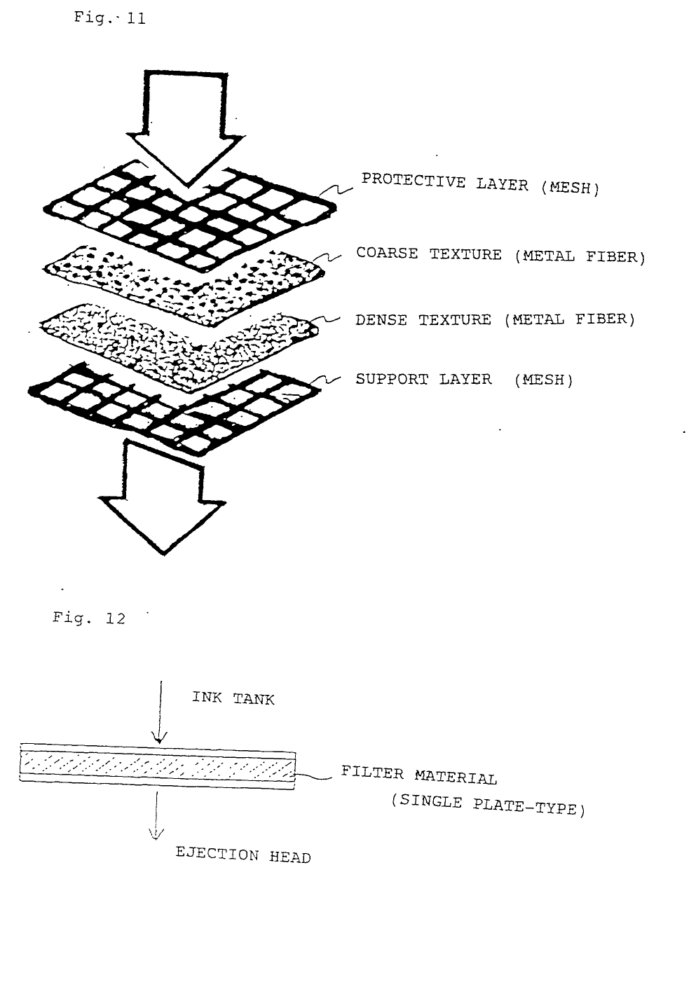

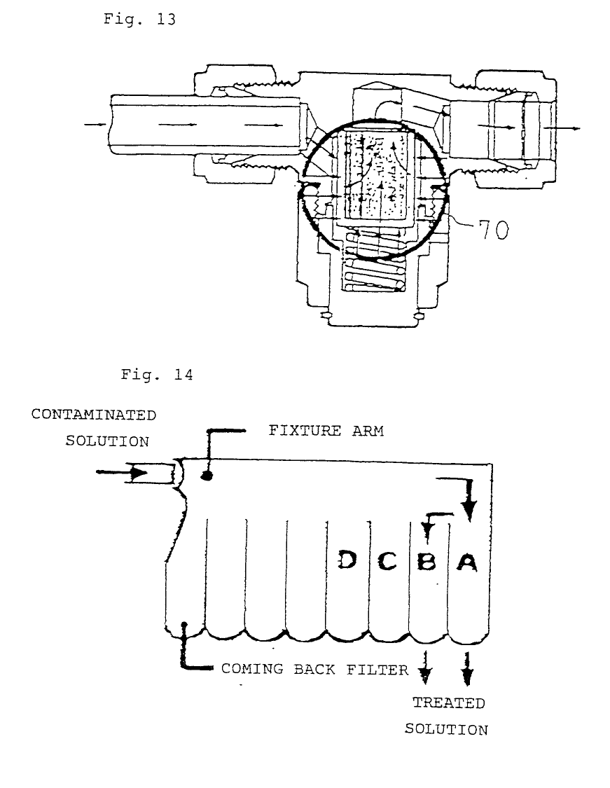

A filter (filter material) 60 is described below using FIGS. 10 to 14. FIG. 10 is a view for explaining pores of the filter 60, FIG. 11 is a perspective view of a multilayer-type filter, FIG. 12 is a sectional view of a single plate-type filter, FIG. 13 is a sectional view of a tea strainer-type filter and FIG. 14 is an explanatory view of a coming back-type filter.

For the filter 60, a stainless steel-made wire-mesh filter material is predominantly used but other than this, construction materials such as paper, plastic (polymer, monomer), metal (SuS, copper) and ceramic are used. The pores for filtration of the filter material have a pore size of about 2 μm to thousands of μm in many cases but various filter materials as shown in FIG. 10 may be used, for example, a membrane filter of the type shown in FIG. 10 (a) where pores having a uniform pore size are continued, a filter of the type shown in FIG. 10(b) where pores are different in the size and shape, or a filter of the type where the pore size is constantly reduced in sequence (not shown). The minimum distance of the pore size is 2 μm or more, preferably 5 μm or more as shown in FIG. 10(b). With respect to the kind of the filter material, a mesh-type filter material, a sintered metal-type filter material, a hollow yarn-type filter material and the like may be used.

With respect to the pore shape, a filter may be constructed such that the pore size is sequentially reduced as in the multilayer form shown in FIG. 11, which is obtained by staking a filter layer having coarse pores and a filter layer having dense pores. The filter of FIG. 11 is constructed to have a structure such that a coarse filter material layer having a large pore size and a dense filter material layer having a small pore size are stacked and a coarse mesh-type protection layer and a coarse mesh-type support layer are provided on the top and bottom thereof, respectively, to sandwich the filter layers. In this case, the filter material is a non-woven metal filter obtained by stacking and then sintering a felt of stainless steel (SUS 316L) metal fibers and housed in a cylindrical case. The filter material used has a thickness on the order of 0.09 to 0.65 mm and a pore size on the order of 3 to 60 μm.

With respect to the shape of the filter material, a single plate-type filter having only one filter material layer shown in FIG. 12, the above-described multilayer-type filter shown in FIG. 11 or a cylinder-type filter obtained by bundling hollow yarns having micropores punched to provide a hollow state and thereby forming a hollow yarn film, may be used. The cylinder-type filter is not particularly shown and this is used in many cases as a water-purifying filter or a filter element for pure water. In addition, a so-called inline T-type tea strainer-type filter shown in FIG. 13 may be used, where a fluid (ink) flows from the outside to the inside of a filter element (e.g., SUS, Al). This filter is conveniently cleaned or exchanged because only the filter element can be easily detached by removing the lower side nut. Furthermore, a coming back-type filter shown in FIG. 14 may be used, which is being used for sewage treatment and the like. In this filter, the chambers A, B, C, D . . . each has a filter function and when a contaminated solution enters into a fixture arm, the solution passes through the fixture arm to flow into a chamber A, the contaminated solution flown in to the chamber A is filtered through a filter, the filtered solution flows downward from the chamber A, and the sludge is accumulated in the chamber A. When the filter in the chamber A is clogged, the contaminated solution then flows into the next chamber B and filtered in the chamber B. The filtered solution flows downward from the chamber B and the sludge is accumulated in the chamber B. When the filter in the chamber B is clogged, the contaminated solution then flows into the next chamber C and thereafter, the filtering is repeated in sequence. In this case, the clogged filters in the chambers A and B are not completely clogged and each chamber still functions as a precipitator. By virtue of such a function, the coming back filter is ensured with a long life and an excellent filtering action. As such, the tea strainer-type filter is characterized in that the filter material itself can be taken out from the housing and exchanged, the hollow yarn-type filter is constructed such that the filter can be exchanged every each cartridge, and filters of other types including the coming back-type filter can be exchanged every each cartridge based on the use time, the number of sheets drawn or the like.

With respect to the countermeasure for clogging of the filter 60, when deposit such as aggregate or dust is accumulated on the filter material such as a mesh, a removing treatment is appropriately performed using removal means such as ultrasonic irradiation, vibration or block flow of ink or cleaning solution. The timing may be controlled to automatically perform the removal at constant time intervals (e.g., use time, number of sheets drawn) or the removal may also be appropriately performed by hand. In the ultrasonic irradiation, stirring member may also be used.

With respect to the filtering system using the filter material described above, the filtration is performed using the following systems individually or in combination, namely, a gravity filtration system of performing the filtration using the gravity of the stock solution (ink) passing through the filter material, a pressure filtration system of filtering ink while pressurizing it by means of a pump, a vacuum filtration system of sucking ink by means of a vacuum pump, and a constant rate filtration system of keeping the ink flow rate constant. The filtering system may be selected from these systems according to the conditions such as disposed position (e.g., disposition immediately before the ejection head, disposition after the pump), construction of single plate-type or multilayer-type, and performance.

Construction examples of various printing apparatuses shown in FIGS. 15 to 20 according to the present invention are described below, where an ink jet drawing device 3 having such filtering member is mounted. However, the present invention is not limited to these construction examples.

FIGS. 15 to 20 each is a view schematically showing a construction example of a printing apparatus where the drawing is performed by moving the printing medium by the rotation of an opposing drum according to the present invention.

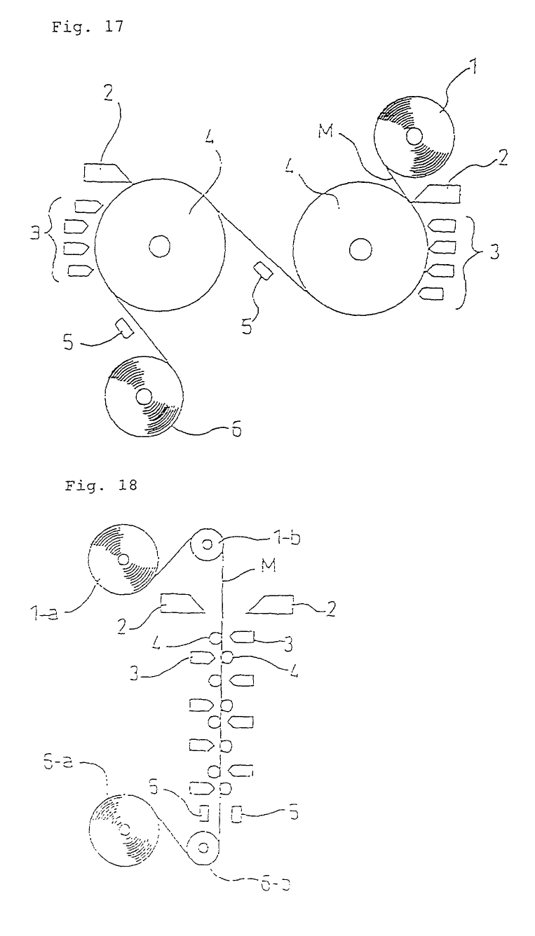

Out of these, FIGS. 15 to 18 each is a view schematically showing a construction example of a web-type printing apparatus where a rolled printing medium is tensioned by putting it over an opposing drum, a printing medium feed roll and a printing medium take-up roll or a guide roll. In these construction examples of the web-type printing apparatus, one-side monochromatic printing is performed in FIG. 15, one-side four-color printing is performed in FIG. 16, and two-side four-color printing is performed in FIGS. 17 and 18.

FIG. 19 is a view schematically showing a construction example of a printing apparatus where one-side four-color printing is performed by cutting a rolled printing medium and winding it around an opposing drum. FIG. 20 is a view schematically showing a construction example of a printing apparatus using a sheet-like recording medium.

On the other hand, FIGS. 21 and 22 each is a view schematically showing a construction example of a printing apparatus according to the present invention, where the drawing is performed by running the printing medium while interposing and holding it between capstan rollers. Out of these schematic construction examples, FIG. 21 shows a printing apparatus using a rolled printing medium and FIG. 22 shows a printing apparatus using a sheet-like recording medium.

The printing step according to the present invention is described using the entire construction view of a printing apparatus for performing one-side one-color printing on a rolled printing medium shown in FIG. 15.

The ink jet printing apparatus (hereinafter sometimes referred to as a “printing apparatus”) shown in FIG. 15 is constructed by a feed roll 1 of feeding a rolled printing medium, a dust/paper dust-removing device 2, an ink jet drawing device 3, an opposing (drawing) drum 4 disposed at the position facing the ink jet drawing device 3 through a printing medium, a fixing apparatus 5 and a printing medium take-up roll 6.

After removing dusts or the like on a printing medium delivered from a feed roll by a dust/paper dust removing apparatus 2, an ink is imagewise ejected from an ejection head 22 of an ink jet drawing device 3 toward the printing medium on the drawing drum 4 and thereby, a printing image is recorded. The image is fixed on the printing medium using a fixing apparatus 5 and then the printing medium after the printing is taken up by a printing medium take-up roll 6.

The opposing (drawing) drum 4 works out to a counter electrode of the ejection electrode in the ink ejection part and therefore, is a metal-made roll, a roll having on the surface thereof an electrically conducting rubber layer, or an insulating drum such as plastic, glass or ceramic after providing a metal layer on the surface thereof using vapor deposition, plating or the like. By using such a roll or drum, an effective electric field can be formed between the ink jet drawing device 3 and the ejecting part. For improving the quality of image drawn, it is also effective to provide heating means in the drawing drum 4 and elevate the drum temperature. The swift fixing of the ejected ink droplets on the printing medium is accelerated and the blurring is more successfully prevented.

By controlling the drum temperature constant, the physical property values of the ink droplet ejected on the printing medium can be controlled and therefore, stable and homogeneous dot formation can be attained. In order to keep the drum at a constant temperature, cooling means is preferably provided together.

For the dust/paper dust-removing member, a known non-contact method such as suction removal, blowing removal or electrostatic removal, or a contact method by a brush, a roller or the like may be used.

In the present invention, either air suction or air blowing, or a combination thereof is preferably used.

The printing medium M delivered from the printing medium feed roll 1 is tensioned by the driving of the printing medium take-up roll 6 to abut on the drawing (opposing) drum 4, whereby the printing medium web is vibrated and prevented from contacting with the ink jet drawing device 3 to cause damages at the time of drawing an image.

Also, means of closely contacting the printing medium M with the drawing (opposing) drum 4 only in the periphery of the drawing position of the ink jet drawing device 3 may be disposed and actuated at least at the time of performing the drawing, whereby the printing medium M can be prevented from contacting with the ink jet drawing device 3. More specifically, for example, a presser roller is disposed upstream and downstream the drawing position of the drawing drum 4, or a guide, electrostatic adsorption or the like is effective.

The oil-based ink image formed is intensified by a fixing apparatus 5. For fixing the ink, known means such as heat-fixing or solvent fixing may be used. In the heat-fixing, hot air fixing by the irradiation of an infrared lamp, a halogen lamp or a xenon flash lamp or using a heater, or heat-roller fixing is generally employed. The flash fixing using a xenon lamp or the like is known as a fixing method of electrophotographic toner and this is advantageous in that the fixing can be performed within a short time. In the case of using a laminate sheet, the water content inside the paper abruptly evaporates due to the abrupt elevation of the temperature and a phenomenon called blister of generating asperities on the paper surface takes place. Therefore, for preventing the blister, it is preferred to dispose a plurality of fixing machines and vary the distance from the power supply and/or the fixing machine to the recording medium so as to gradually elevate the paper temperature.

In the solvent fixing, a solvent capable of dissolving the resin components in the ink, such as methanol or ethyl acetate, is sprayed or the printing medium is exposed to the solvent vapor while recovering excess solvent vapor.

At least in the process from the formation of an oil-based ink image by the ejection head 22 until the fixing by the fixing apparatus 5, the formed image on the printing medium is preferably kept not to come into contact with any thing.

FIGS. 16 to 18 each is a construction example of a one-side four-color printing apparatus or a two-side four-color printing apparatus. The principle of operation thereof and the like can be easily understood from the above-described description of the one-side monochromatic printing apparatus and therefore, these are not described here.

A construction example of a four-color printing apparatus is described here, however, the present invention is not limited thereto and the number of colors are freely selected depending on the case.

FIGS. 19 and 20 each is another construction example according to the present invention for explaining a printing apparatus where an automatic discharge device 7 is provided and the printing medium M is used by winding it around an opposing drum 4. FIG. 20 is a construction example for explaining a printing apparatus having an automatic feed device 9 and using a sheet-like printing medium. The present invention is described here by referring to the construction example of an apparatus using a rolled printing medium M of FIG. 19.

The printing medium M is delivered from the printing medium feed roll 1, cut into an arbitrary size by a cutter 8 and then fixed on an opposing drum 4. At this time, the printing medium may be closely fixed on the drum 4 by a known mechanical method such as sheet head/edge gripping device or air suction device, or by an electrostatic method, whereby the sheet edge can be prevented from fluttering and contacting with an ink jet drawing device 3 to cause damages at the time of drawing.

Also, means of closely contacting the printing medium M with the drum 4 only in the periphery of the drawing position of the ink jet drawing device 3 may be disposed and actuated at least at the time of performing the drawing, whereby the printing medium M can be prevented from contacting with the ink jet recording device 3. More specifically, for example, a presser roller is disposed upstream and downstream the drawing position of the opposing drum 4.

The head is preferably separated from the printing medium M during the time period of not performing the drawing, whereby troubles such as damage due to contacting can be effectively prevented from occurring on the ink jet drawing device 3.

The ejection head 22 (FIG. 1) which can be used is a single channel head, a multi-channel head or a full line head, and the main scanning is performed by the rotation of the opposing drum 4. In the case of a multi-channel head or a full line head having a plurality of ejection parts, the head is disposed to array the ejection parts in the direction parallel to the axis of the opposing drum 4.

In the case of a single channel head or a multi-channel head, the ejection head 22 is continuously or sequentially moved in the direction parallel to the axis of the opposing drum by the image data arithmetic and control part 21 and ejects an oil-based ink on the printing medium M fixed to the opposing drum 4 based on the ejection position and the halftone dot area ratio obtained by the computation of the image data arithmetic and control part 21. By this ejection, a halftone image is drawn by the oil-based ink according to the variable density of the printing original. This operation continues until a predetermined oil-based ink image is formed on the printing medium M.

On the other hand, in the case where the ejection head 22 is a full line head having almost the same length as the width of the drum, an oil-based ink image is formed on the opposing drum 4 by one rotation of the drum and a printed matter is accomplished. As such, the main scanning is performed by the rotation of the drum, so that the positional precision in the main scan direction can be elevated and the drawing can be performed at a high speed. The printing medium M printed is fixed using a fixing apparatus 5 and then discharged by an automatic discharge device 7.

A construction example of a four-color printing apparatus is described here, however, the present invention is not limited thereto and the number of colors, the one-side or two-side printing, and the construction of the device can be freely selected depending on the case.

FIGS. 21 and 22 each is a view schematically showing a construction example of a printing apparatus where an image is formed by running a printing medium M while interposing and holding it between capstan rollers according to the present invention. Of these schematic views showing a construction example, FIG. 21 is a printing apparatus using a rolled printing medium M and FIG. 22 is a printing apparatus using a sheet-like printing medium M.

The present invention is described here by referring to the entire construction example of an apparatus for performing one-side four-color printing on a rolled printing medium M shown in FIG. 21. The printing medium M is delivered while being interposed and held between two pairs of captain rollers 10. Using data partitioned and computed into appropriate number of picture elements and number of gradations by an image data arithmetic and control part (21 of FIG. 1), an image is drawn by an ink jet drawing device 3. In the position where an image is drawn by the ink jet drawing device 3, earth means 11 is preferably provided to work as a counter electrode of the ejection head electrode at the time of electrostatic ejection, whereby the drawing is facilitated.

In FIG. 21, a sheet cutter 8 for cutting a rolled printing medium M is provided upstream the automatic discharge device 7, however, the sheet cutter 8 can be disposed at any appropriate position.

A process of preparing a printed matter using the printing apparatus of the present invention is described in detail below by referring to FIG. 21.

A printing medium M is transported using capstan rollers 10. At this time, if desired, printing medium guide means (not shown) may be provided, whereby the head/edge of the printing medium M can be prevented from fluttering and contacting with an ink jet drawing device 3 to cause damages. Furthermore, means of preventing loosening of the printing medium M only in the periphery of the drawing position of the ink jet drawing device 3 may be provided and by actuating this means at least at the time of performing the drawing, the printing medium M can be prevented from contacting with the ink jet drawing device 3. To speak specifically, for example, a method of disposing a presser roller upstream and downstream the drawing position may be used.

The head is preferably separated from the printing medium M during the time period of not performing the drawing, whereby troubles such as damage due to contacting can be effectively prevented from occurring on the ink jet drawing device 3.

The image data from a magnetic disc device or the like is sent to an image data arithmetic and control part 21 of FIG. 1 and according to the input image data, the image data arithmetic and control part 21 computes the position of ejecting an oil-based ink and the halftone dot area ratio at that position. These computed data are once stored in a buffer.

The image data arithmetic and control part 21 controls the timing of moving the ejection head 22, ejecting an oil-based ink and operating the capstan rollers 10 and if desired, approximates the ejection head 22 to the position proximate to the printing medium M using a head-retreating or approximating device 31 (FIG. 1). The ejection head 22 and the surface of the printing medium M are kept at a predetermined distance during the drawing using mechanical distance controlling member such as knock roller or by the control of the head-retreating or approximating device based on the signals from an optical distance detector. By virtue of this distance control, good printing can be performed without causing non-uniformity in the dot size because of floating of the printing medium or without causing any change in the dot size particularly when vibration is applied to the printing apparatus.

For the ejection head 22, a single channel head, a multi-channel head or a full line head may be used and the sub scanning is performed by the transportation of the printing medium. In the case of a multi-channel head having a plurality of ejection parts, the head is disposed such that the ejection parts are arrayed in almost parallel to the running direction of the printing medium M. Furthermore, in the case of a single channel head or a multi-channel head, the ejection head 22 is moved in the direction at a right angle to the running direction of the printing medium M by the image data arithmetic and control part 21 and ejects an oil-based ink based on the ejection position and the halftone dot area ratio obtained by the computation. By this ejection, a halftone image is drawn by the oil-based ink according to the variable density of the printing original. This operation continues until a predetermined oil-based ink image is formed on the printing medium M. On the other hand, in the case where the ejection head 22 is a full line head having almost the same length as the width of the drum, the head is disposed to array the ejection parts almost at a right angle to the running direction of the printing medium and an oil-based ink image is formed on the printing medium M by passing the printing medium M through the drawing part. The printing medium M printed is fixed by a fixing apparatus 5 and then discharged by an automatic discharge device.

A construction example of a one-surface four-color printing apparatus is described here, however, the present invention is not limited thereto and the number of colors and the one-side or two-side printing are freely selected depending on the case.

The printing medium M for use in the present invention is described below.

Examples of the printing medium include printing paper sheets commonly used, such as wood-free paper, fine coated paper and coated paper. In addition, paper sheets having thereon a resin film layer, such as polyolefin laminated paper, and plastic films such as polyester film, polystyrene film, vinyl chloride film and polyolefin film, may also be used. Furthermore, plastic film or processed paper on the surface of which a metal is deposited or a metal foil is laminated, may also be used. Of course, paper or film exclusive for ink jet printing can be used.

The oil-based ink for use in the present invention is described below.

The oil-based ink for use in the present invention is obtained by dispersing at least colored particles in a non-aqueous solvent having an electric resistivity of 10⁹ Ωcm or more and a dielectric constant of 3.5 or less.

The non-aqueous solvent having an electric resistivity of 10⁹ Ωcm or more and a dielectric constant of 3.5 or less for use in the present invention is preferably a linear or branched aliphatic hydrocarbon, an alicyclic hydrocarbon, an aromatic hydrocarbon or a halogen substitution product of these hydrocarbons. Examples thereof include hexane, heptane, octane, isooctane, decane, isodecane, decalin, nonane, dodecane, isododecane, cyclohexane, cyclooctane, cyclodecane, benzene, toluene, xylene, mesitylene, Isoper C, Isoper E, Isoper G, Isoper H, Isoper L (Isoper: a trade name of Exxon Corp.), Shellsol 70, Shellsol 71 (Shellsol: a trade name of Shell Oil Corp.), Amsco OMS solvent, Amsco 460 solvent (Amsco: a trade name of American Mineral Spirits Co.), and silicone oil. These are used individually or in combination. The upper limit of the electric resistivity of the non-aqueous solvent is about 10¹⁶ Ωcm and the lower limit of the dielectric constant is about 1.9. The non-aqueous solvent is used as a cleaning solution individually or in combination with another solvent.

The electric resistance of the non-aqueous solvent is specified to the above-described range because if the electric resistance is less than this range, colored particles or the like are not easily concentrated, the dots formed are colored thinly or bleeding is generated. The dielectric constant is specified to the above-described range because if the dielectric constant exceeds this range, the electric field is relaxed due to polarization of the solvent and thereby, the ink is poorly ejected.

In dispersing colored particles in the non-aqueous solvent, a coloring material itself may be dispersed as disperse particles in a non-aqueous solvent or may be incorporated into a disperse resin particle for improving the fixing property. In the case of incorporating the coloring material into the resin particle, a method of covering the coloring material with a resin material of the disperse resin particle to form a resin-coated particle is generally used for a pigment and a method of coloring the disperse resin particle to form a colored particle is generally used for a dye.

The coloring material may be any as long as it is a pigment or a dye conventionally used for oil-based ink compositions or liquid developers for electrostatic photography.

With respect to the pigment, those commonly used in the technical field of printing may be used irrespective of an inorganic pigment or an organic pigment. Specific examples thereof include known pigments such as carbon black, cadmium red, molybdenum red, chrome yellow, cadmium yellow, titanium yellow, chromium oxide, viridian, cobalt green, ultramarine blue, Prussian blue, cobalt blue, azo-type pigments, phthalocyanine-type pigments, quinacridone-type pigments, isoindolinone-type pigments, dioxazine-type pigments, threne-type pigments, perylene-type pigments, perinone-type pigments, thioindigo-type pigments, quinophthalone-type pigments and metal complex pigments. These can be used without any particular limitation.

The dye is preferably an oil-soluble dye such as azo dye, metal complex salt dye, naphthol dye, anthraquinone dye, indigo dye, carbonium dye, quinoneimine dye, xanthene dye, aniline dye, quinoline dye, nitro dye, nitroso dye, benzoquinone dye, naphthoquinone dye, phthalocyanine dye and metallo-phthalocyanine dye.

These pigments and dyes may be used individually or in an appropriate combination. The coloring material is preferably contained in an amount of 0.5 to 5 wt % based on the entire ink.

In the oil-based ink for use in the present invention, a disperse resin particle for improving the fixing property of the image after printing is preferably contained together with the colored particle.

The resin particle dispersed in the non-aqueous solvent may be sufficient if it is a hydrophobic resin particle which is solid at a temperature of 35° C. or less and has high affinity for the non-aqueous solvent. However, the resin particle is preferably a resin (P) having a glass transition point of −5 to 110° C. or a softening point of 33 to 140° C., more preferably having a glass transition point of 10 to 100° C. or a softening point of 38 to 120° C., still more preferably having a glass transition point of 15 to 80° C. or a softening point of 38 to 100° C.

By using a resin having such a glass transition point or a softening point, the affinity between the surface of the printing medium and the resin particle increases and the bonding among resin particles is intensified on the printing medium, so that the adhesion between the image area and the surface of the printing medium is improved and the rubbing resistance is also improved. If the glass transition point or softening point is lower or higher than the above-described range, the affinity between the surface of the printing medium and the resin particle or the bonding force among resin particles may decrease.

The weight average molecular weight (Mw) of the resin (P) is from 1×10³ to 1×10⁶, preferably from 5×10³ to 8×10⁵, more preferably from 1×10⁴ to 5×10⁵.

Specific examples of the resin (P) include olefin polymers and copolymers (for example, polyethylene, polypropylene, polyisobutylene, ethylene-vinyl acetate copolymer, ethylene-acrylate copolymer, ethylene-methacrylate copolymer and ethylene-methacrylic acid copolymer), vinyl chloride polymers and copolymers (for example, polyvinyl chloride and vinyl chloride-vinyl acetate copolymer), vinylidene chloride copolymers, vinyl alkanoate polymers and copolymers, allyl alkanoate polymers and copolymers, polymers and copolymers of styrene and derivatives thereof (for example, butadiene-styrene copolymer, isoprene-styrene copolymer, styrene-methacrylate copolymer and styrene-acrylate copolymer), acrylonitrile copolymers, methacrylonitrile copolymers, alkyl vinyl ether copolymers, acrylic acid ester polymers and copolymers, methacrylic acid ester polymers and copolymers, itaconic acid diester polymers and copolymers, maleic acid anhydride copolymers, acrylamide copolymers, methacrylamide copolymers, phenolic resins, alkyd resins, polycarbonate resins, ketone resins, polyester resins, silicon resins, amide resins, hydroxyl group- or carboxyl group-modified polyester resins, butyral resins, polyvinyl acetal resins, urethane resins, rosin-type resins, hydrogenated rosin resins, petroleum resins, hydrogenated petroleum resins, maleic acid resins, terpene resins, hydrogenated terpene resins, chroman-indene resins, cyclic rubber-methacrylic acid ester copolymers, cyclic rubber-acrylic acid ester copolymers, copolymers containing a heterocyclic ring having no nitrogen atom (examples of the heterocyclic ring include furan ring, tetrahydrofuran ring, thiophene ring, dioxane ring, dioxofuran ring, lactone ring, benzofuran ring, benzothiophene ring and 1,3-dioxetane ring), and epoxy resins.

The total content of colored particles and resin particles dispersed in the oil-based ink for use in the present invention is preferably from 0.5 to 20 wt % based on the entire ink. If the content is less than this range, problems are liable to arise, for example, the printed image is deficient in the density or the ink can hardly have affinity for the surface of the printing medium to fail in obtaining a firm image. On the other hand, if the content exceeds the above-described range, uniform dispersion may not be easily obtained or non-uniform ink flow readily occurs in the ejection head to fail in attaining stable ink ejection.

The particles dispersed in the non-aqueous solvent for use in the present invention, including the colored particles and further resin particles, preferably have an average particle size of 0.05 to 5 μm, more preferably from 0.1 to 1.5 μm, still more preferably from 0.4 to 1.0 μm. This particle size is determined by CAPA-500 (trade name, manufactured by Horiba Seisakusho Co., Ltd.).

The non-aqueous disperse colored particle for use in the present invention may be produced by a conventionally known mechanical grinding method or polymerizing granulation method. Examples of the mechanical grinding method include a method where if desired, a colorant and a resin are mixed, these are melted, kneaded and directly ground into fine particles by a conventionally known grinder and the fine particles are dispersed using a dispersion polymer in combination by a wet dispersing machine (for example, ball mill, paint shaker, Kedy mill and Dyno mill), and a method where a coloring material as a colored particle component and a dispersion aid polymer (or covering polymer) are previously kneaded and the kneaded product is ground and then dispersed in the presence of a dispersion polymer. Specifically, a production process of coating materials or liquid developers for electrostatic photography may be utilized and this is described, for example, in Kenji Ueki (supervisor of translation), Toryo no Ryudo to Ganryo Bunsan (Flow of Coating Materials and Dispersion of Pigments), Kyoritsu Shuppan (1971), Solomon, Toryo no Kagaku (Science of Coatings), Hirokawa Shoten (1969), Yuji Harasaki, Coating Kogaku (Coating Engineering), Asakura Shoten (1971), and Yuji Harasaki, Coating no Kiso Kagaku (Basic Science of Coating), Maki Shoten (1977).

A method of granulating resin particles by a polymerizing granulation method and coloring the resin particles with a dye to produce colored particles may also be used. Examples of the polymerizing granulation method include a conventionally known non-aqueous dispersion polymerization method and this is specifically described, for example, in Soichi Muroi (supervisor of compilation), Cho-Biryushi Polymer no Saishin Gijutsu (Latest Technology of Ultrafine Polymers), Chapter 2, CMC Shuppan (1991), Koichi Nakamura (compiler), Saikin no Denshi-Shasin Genzo System to Toner Zairyo no Kaihatsu/Jitsuyoka (Recent Electrophotographic Developing Systems and Development and Practical Use of Toner Materials), Chapter 3, Nippon Kagaku Joho K. K. (1985), and K. E. J. Barrett, Dispersion Polymerization in Organic Media, John Wiley (1975).

In order to dispersion-stabilizing the dispersed particles in the non-aqueous solvent, a dispersion polymer is usually used in combination. The dispersion polymer mainly comprises a repeating unit soluble in the non-aqueous solvent and preferably has a weight average molecular weight (Mw) of 1×10³ to 1×10⁶, more preferably from 5×10³ to 5×10⁵.

The preferred soluble repeating unit of the dispersion polymer for use in the present invention includes a polymerization component represented by the following formula (I):

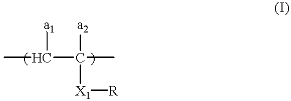

wherein X₁ represents —COO—, —OCO— or —O—, R represents an alkyl or alkenyl group having from 10 to 32 carbon atoms, preferably an alkyl or alkenyl group having from 10 to 22 carbon atoms (the alkyl or alkenyl group may be linear or branched and may have a substituent but the alkyl or alkenyl group is preferably unsubstituted, and specific examples thereof include a decyl group, a dodecyl group, a tridecyl group, a tetradecyl group, a hexadecyl group, an octadecyl group, an eicosanyl group, a docosanyl group, a decenyl group, a dodecenyl group, a tridecenyl group, a hexadecenyl group, an octadecenyl group and a linoleyl group), and a₁ and a₂, which may be the same or different, each represents a hydrogen atom, a halogen atom (e.g., chlorine, bromine), a cyano group, an alkyl group having from 1 to 3 carbon atoms (e.g., methyl, ethyl, propyl), —COO—Z₁ or —CH₂COO—Z₁ (wherein Z₁ represents a hydrocarbon group having 22 or less carbon atoms, which may be substituted, such as alkyl group, alkenyl group, aralkyl group, alicyclic group and aryl group, and among the hydrocarbon groups represented by Z₁, preferred hydrocarbon groups are an alkyl group having from 1 to 22 carbon atoms, which may be substituted, such as methyl group, ethyl group, propyl group, butyl group, hexyl group, heptyl group, octyl group, nonyl group, decyl group, dodecyl group, tridecyl group, tetradecyl group, hexadecyl group, octadecyl group, eicosanyl group, docosanyl group, 2-chloroethyl group, 2-bromoethyl group, 2-cyanoethyl group, 2-methoxycarbonylethyl group, 2-methoxyethyl group and 3-bromopropyl group; an alkenyl group having from 4 to 18 carbon atoms, which may be substituted, such as 2-methyl-1-propenyl group, 2-butenyl group, 2-pentenyl group, 3-methyl-2-pentenyl group, 1-pentenyl group, 1-hexenyl group, 2-hexenyl group, 4-methyl-2-hexenyl group, decenyl group, dodecenyl group, tridecenyl group, hexadecenyl group, octadecenyl group and linolenyl group; an aralkyl group having from 7 to 12 carbon atoms, which may be substituted, such as benzyl group, phenethyl group, 3-phenylpropyl group, naphthylmethyl group, 2-naphthylethyl group, chlorobenzyl group, bromobenzyl group, methylbenzyl group, ethylbenzyl group, methoxybenzyl group, dimethylbenzyl group and dimethoxybenzyl group; an alicyclic group having from 5 to 8 carbon atoms, which may be substituted, such as cyclohexyl group, 2-cyclohexylethyl group and 2-cyclopentylethyl group; and an aromatic group having from 6 to 12 carbon atoms, which may be substituted, such as phenyl group, naphthyl group, tolyl group, xylyl group, propylphenyl group, butylphenyl group, octylphenyl group, dodecylphenyl group, methoxyphenyl group, ethoxyphenyl group, butoxyphenyl group, decyloxyphenyl group, chlorophenyl group, dichlorophenyl group, bromophenyl group, cyanophenyl group, acetylphenyl group, methoxycarbonylphenyl group, ethoxycarbonylphenyl group, butoxycarbonylphenyl group, acetamidophenyl group, propionamidophenyl group and dodecyloylamidophenyl group).

The dispersion polymer may contain another repeating unit as a copolymerization component together with the repeating unit represented by formula (I). The another copolymerization component may be any compound as long as it comprises a monomer copolymerizable with the monomer corresponding to the repeating unit represented by formula (I).

The ratio of the polymer component represented by formula (I) present in the dispersion polymer is preferably 50 wt % or more, more preferably 60 wt % or more.

Specific examples of the dispersion polymer include Resin (Q-1) for dispersion stabilization used in Examples. Also, commercially available products (for example, Solprene 1205, produced by Asahi Chemical Industry Co., Ltd.) may be used.

In the case of producing the particles of Resin (P) as a dispersion (latex) or the like, the dispersion polymer is preferably added in advance to the polymerization.

The amount added of the dispersion polymer is approximately from 1 to 50 wt % based on Resin (P) for particles.

The colored particle (or coloring material particle) and the dispersed resin particle in the oil-based ink for use in the present invention each is preferably an electroscopic particle bearing positive or negative charge.

For imparting electroscopicity to these particles, this may be achieved by appropriately using a technique of developers for wet electrostatic photography. To speak specifically, the electroscopicity is imparted using an electroscopic material such as charge controlling agent, and other additives described, for example, in Saikin no Denshi-Shasin Genzo System to Toner Zairyo no Kaihatsu/Jitsuyoka (Recent Electrophotographic Developing Systems and Development and Practical Use of Toner Materials), supra, pp. 139-148, Denshi Shashin Gijutsu no Kiso to Oyo (Elementary Study and Application of Electrophotographic Technology), Denshi Shashin Gakkai (compiler), pp. 497-505, Corona Sha (1988), and Yuji Harasaki, Denshi Shashin (Electrophotography), 16 (No. 2), page 44 (1977).

This is more specifically described, for example, in British Patents 893,429, 934,038 and 1,122,397, U.S. Pat. Nos. 3,900,412 and 4,606,989, JP-A-60-179751, JP-A-60-185963 and JP-A-2-13965.

The amount of such a charge controlling agent is preferably from 0.001 to 1.0 part by weight per 1,000 parts by weight of the dispersion medium as a carrier liquid. If desired, various additives may be further added and the upper limit of the total amount of these additives is determined by the electric resistance of the oil-based ink. More specifically, if the electric resistance of the ink in the state where dispersed particles are removed is less than 10⁹ Ωcm, an image with good continuous gradation may not be obtained. Therefore, the amounts of the additives are preferably controlled with this limit.

The present invention will be described in greater detail by referring to the following Examples, but the invention should not be construed as being limited thereto.

A production example of Resin Particle (PL-1) for ink is described below.

### PRODUCTION EXAMPLE 1

### Production of Resin Particle (PL-1)

A mixed solution containing 10 g of Resin (Q-1) for dispersion stabilization having a structure shown below, 100 g of vinyl acetate and 384 g of Isoper H was heated to a temperature of 70° C. while stirring in a nitrogen stream. Thereto, 0.8 g of 2,2′-azobis(isovaleronitrile) (hereinafter simply referred to as “A.I.V.N.”) was added as a polymerization initiator and the reaction was performed for 3 hours. 20 Minutes after the addition of the initiator, the solution turned to milky white and the reaction temperature was elevated to 88° C. Thereto, 0.5 g of the same initiator was further added and the reaction was performed for 2 hours. Thereafter, the temperature was elevated to 100° C., the reaction solution was stirred for 2 hours, and unreacted vinyl acetate was removed by distillation. The residue was cooled and passed through a 200-mesh nylon cloth. The white dispersion obtained was a latex having a polymerization ratio of 90%, an average particle size of 0.23 μm and good monodispersity. The particle size was measured by CAPA-500 (manufactured by Horiba Seisakusho K. K.).

Resin (Q-1) for Dispersion Stabilization:

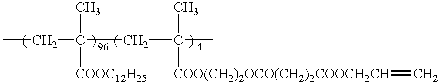

Mw: 5×10⁴

A part of this white dispersion was centrifuged (revolution number: 1×10⁴ rpm, revolution time: 60 minutes) and the precipitated resin particle portion was collected and dried. The resin particle portion had a weight average molecular weight (Mw, GPC value in terms of polystyrene) of 2×10⁵ and a glass transition point (Tg) of 38° C.

### EXAMPLE 1

An oil-based ink was prepared.

### Preparation of Oil-based Ink (IK-2)

Into a paint shaker (manufactured by Toyo Seiki K. K.), 10 g of dodecyl methacrylate/acrylic acid copolymer (copolymerization ratio: 95/5 by weight), 10 g of nigrosine and 30 g of Shellsol 71 were charged together with glass beads and dispersed for 4 hours to obtain a fine nigrosine dispersion.

Then, 30 g (as solid contents) of Resin Particle (PL-1) produced in Preparation Example 1 of Resin Particle for Ink, 20 g of the nigrosine dispersion prepared above, 15 g of FOC-1400 (tetradecyl alcohol, produced by Nissan Chemical Industries Co., Ltd.) and 0.08 g of an octadecene-half maleic acid octadecylamide copolymer were diluted with 1 liter of Isoper G to prepare a black oil-based ink.

Thereafter, 2 liter of the thus-prepared oil-based ink (IK-1) was filled in an ink tank of an ink jet drawing device 3 of a printing apparatus shown in FIG. 15. The ejection head used here was a 900 dpi full line head of the type shown in FIG. 5 and a filter 60 was inserted into the ink inflow passage. In the ink tank, an immersion heater and a stirring blade were provided as the ink temperature-controlling member and by setting the ink temperature to 30° C., the temperature was controlled using a thermostat while rotating the stirring blade at 30 rpm. The stirring blade used here was also served as stirring member for preventing precipitation and coagulation. A part of the ink passage was made transparent, and an LED light-emitting device and a light-detecting device were disposed to sandwich the transparent portion. Based on the output signal therefrom, the concentration was controlled by charging a diluting solution (Isoper G) or a concentrated ink (prepared by adjusting the solid concentration of Ink (IK-1) to 2 times). A rolled fine coated paper as a printing medium was placed on an opposing drum and transported. The dusts on the surface of the printing medium was removed by an air pump suction and then the ejection head was approximated to the printing medium and stopped at the drawing position. The image data to be printed was transmitted to the image data arithmetic and control part and while delivering the printing medium by the rotation of the opposing drum, an oil-based ink was ejected from a full-line multi-channel head to form an image. At this time, the ejection electrode of the ink jet head had a tip width of 10 μm and the distance between the head and the printing medium was kept at 1 mm by the output from an optical gap detecting device. A voltage of 2.5 KV was always applied as a bias voltage and at the time of performing the ejection, a pulse voltage of 500 V was superimposed. The pulse voltage was changed through 256 stages in the range from 0.2 to 0.05 msec so as to perform the drawing while changing the dot area. As a result, good printing was attained, where drawing failure due to ink aggregate or mingling of foreign matters such as dusts was not observed at all and the image was completely free of deterioration due to change in the dot size even when the ambient temperature was changed or the printing time increased.

The image was further firmly fixed by the heating using a xenon flash fixing apparatus (manufactured by Ushio Denki, emission intensity: 200 J/pulse). After the completion of printing, the ink jet drawing device was retreated 50 mm from the position proximate to the drawing drum so as to protect the ink jet head.

The resulting printed matter had a very clear printed image free of slipping or thinning. 10 Minutes after the completion of printing, Isoper G was fed to the head and the head was cleaned by dripping Isoper G from the head opening and then stored in a cover filled with a vapor of Isoper G, as a result, good printed matters could be prepared without requiring any maintenance operation for 3 months.

### EXAMPLE 2

In this Example, a printing apparatus shown in FIGS. 16 and 17 was used, where a circulation pump as the stirring member (27 of FIG. 1) and four units of 150-dpi 64-channel multi-channel heads of the type shown in FIG. 5 were used and the heads each was disposed to array the ejection parts of 64 channels in the direction right angled to the axial direction of the drum.

Four color oil-based inks were used, namely, black ink IK-1, cyan ink IK-2 prepared in the same manner as IK-1 except for using Phthalocyanine Blue in place of nigrosine used as a coloring agent of IK-1, magenta ink IK-3 prepared in the same manner as IK-1 except for using CI pigment red 57:1 in place of nigrosine used as a coloring agent of IK-1, and yellow ink IK-4 prepared in the same manner as IK-1 except for using CI pigment yellow 14 in place of nigrosine used as a coloring agent of IK-1. These inks were filled in four heads, respectively.

In this Example, a pump was used and an ink reservoir was provided between this pump and the ink inflow passage of the ejection head and between the ink recovery passage of the ejection head and the ink tank. The ink was circulated using the difference in the hydrostatic pressure between these ink reservoirs. A heater and the above-described pump were used as the ink temperature-controlling member and the ink temperature was set to 35° C. and controlled by a thermostat. The circulating pump used here was served also as the stirring member for preventing the precipitation and coagulation. Immediately before the ejection head, a filter 60 was disposed. Also, an electrical conductivity-measuring device was disposed on the ink passage and based on the output signals therefrom, the concentration was controlled by diluting the ink or charging a concentrated ink. After removing dusts on the surface of the printing medium using a nylon-made rotary brush, the image data to be printed were transmitted to the image data arithmetic and control part. Then, the head was moved in the direction parallel to the axis of the drum to perform main scanning and at the same time, sub-scanning was performed while rotating the drawing drum, thereby performing the drawing by ejecting an ink on a rolled fine coated paper to form an image.

Drawing failure and the like ascribable to ink aggregates, mingling of foreign matters such as powder dust, or dusts were not observed at all and even with changes in the ambient temperature or increase in the number of printed sheets, the image was completely free from deterioration due to change in the dot size and the like. In either case of using an ejection head of the type shown in FIG. 5 or 7, good one-side or two-side full color printing could be performed.

When after the completion of printing, Isoper G was circulated to the head and then a non-woven fabric impregnated with Isoper G was contacted with the head tip to perform the cleaning, good printed matters could be prepared without requiring any maintenance operation for 3 months.

Furthermore, the image drawing and printing were performed in the same manner except for using a 150 dpi multi-channel head with 64 channels of the type shown in FIG. 7 in place of the ink jet head of the type shown in FIG. 5, as a result, good results were obtained similarly to the above.

### EXAMPLE 3

Using the printing apparatus shown in FIG. 19, full color printing of one-side four-color printing was performed. Four color inks described in Example 2 were used for four sets of ink jet drawing devices, respectively, and 4 units of 100 dpi multi-channel heads with 256 channels of the type shown in FIG. 9 were used and each was disposed to array the ejection parts in parallel with the axis of the opposing drum. The main scanning was performed by the rotation of the opposing drum and a 900 dpi image was drawn on coated paper by sequentially moving the heads in the direction parallel to the axis of the drum every each rotation. As a result, drawing failure or the like due to ink aggregates, mingling of foreign matters such as powder dust, or dusts was not observed at all and a clear and high-quality full color printed matter was obtained.

### EXAMPLE 4

Using a printing apparatus shown in FIGS. 21 and 22, full color printing of one-side four-color printing was performed. The oil-based inks were the same four color inks as used in Example 3. The ejection head used in this Example was a 600 dpi multi-channel head with 64 channels of the type shown in FIG. 5 and the head was disposed to array the ejection parts at an angle of about 60° with respect to the running direction of the printing medium. The image data to be printed were transmitted to the image data arithmetic and control part and a 700 dpi image was formed on paper exclusive for ink jet printing by transporting a printing medium using the rotation of capstan rollers while moving the multi-channel head with 64 channels in the direction right angled to the transportation direction of the printing medium. Other operations were the same as in Example 1. As a result, drawing failure or the like due to ink aggregates, mingling of foreign matters such as powder dust, or dusts was not observed at all and good full-color printing of four colors could be attained.

Also, comparative examples were performed in the same manner as in Examples 1 to 4 except for not using a filter 60. In any example, the ejection of an ink from the ejection head became unstable within a few hours to a few days. At the worst, after image disorder or non-ejection state continued, the ejection port of the head was completely clogged by coarse semi-solid aggregates of ink particles and the drawing could not be performed.

According to the present invention, in an ink jet printing process where an image is formed directly on a printing medium by an ink jet method of ejecting an oil-based ink using an electrostatic field based on signals of image data and the image is fixed to obtain a printed matter, the oil-based ink is used after filtering it, so that the ink fed to an ejection head can be free of ink aggregates or mingling of foreign matters such as dust, image blurring does not occur even when an expensive exclusive paper sheet is not used and printing is performed on a normal printing paper or a non-absorptive medium such as plastic sheet, fine ink droplets can be ejected, individual dot images obtained can be in turn reduced in the area and in the thickness, and therefore, high-grade printing of image information comparable to a photographic image can be performed inexpensively and quickly.

While the invention has been described in detail and with reference to specific embodiments thereof, it will be apparent to one skilled in the art that various changes and modifications can be made therein without departing from the spirit and scope thereof.

What is claimed is:

1. An ink jet printing process comprising:
filtering an oil-based ink;
forming an image directly on a printing medium by an ink jet method comprising ejecting said filtered oil-based ink using electrostatic field based on signals of image data; and
fixing said formed image to obtain a printed matter.

2. The ink jet printing process according to claim 1, wherein said oil-based ink comprises:
a nonaqueous solvent having an electric resistivity of 10⁹ Ωcm or more and a dielectric constant of 3.5 or less; and
a component dispersed in said nonaqueous solvent, which comprises at least colored particles.

3. A printing apparatus comprising:
image-forming unit which directly forms an image on a printing medium based on signals of image data; and
image-fixing unit which fixes the formed image to obtain a printed matter,
wherein said image-forming unit comprises an ink jet drawing device which ejects an oil-based ink from an ejection head using electrostatic field and which has at least one ink-filtering member provided in an ink passage.

4. The printing apparatus according to claim 3, wherein said filtering member is provided at a portion immediately preceding an ink ejection part of said ejection head.

5. The printing apparatus according to claim 3, wherein said filtering member comprises a filter material which blocks coarse aggregates of said ink and foreign matters including dust mingled during the drawing.

6. The printing apparatus according to claim 5, wherein said filter material has pores having various shapes and sizes, each of said pores having a minimum pore distance of not less than 2 μm.

7. The printing apparatus according to claim 5, wherein said filter material has a single-layer or multilayer structure.

8. The printing apparatus according to claim 7, wherein said multilayer filter material comprises filter material layers including: a coarsest protective body and a coarsest support provided in an upstream side and a downstream side, respectively; and filter material layers provided between said protective body and support in such a manner that the pore sizes of the layers are sequentially reduced toward the downstream side.

9. The printing apparatus according to claim 5, wherein said filter material has at least one figuration selected from the group consisting of single plate form, tea strainer form, coming back form and cylinder form.

10. The printing apparatus according to claim 5, wherein said filter material comprises as least one material selected from the group consisting of paper, plastic, metal, ceramic and glass.

11. The printing apparatus according to claim 5, wherein said filter material is of cartridge-type and exchangeable.

12. The printing apparatus according to claim 5, further comprising a filter material accumulation-removing member which removes substances accumulated on said filter material.

13. The printing apparatus according to claim 12, wherein said removal of the filter material accumulation is performed by at least one means of ultrasonic irradiation, vibration and back flow of said ink or a cleaning solution.

14. The printing apparatus according to claim 13, wherein said filtering member comprises at least one filtering systems selected from gravity filtration, pressure filtration, vacuum filtration and constant rate filtration.

15. The printing apparatus according to claim 3, wherein said oil-based ink comprises:
a nonaqueous solvent having an electric resistivity of 10⁹ Ωcm or more and a dielectric constant of 3.5 or less; and
a component dispersed in said nonaqueous solvent, which comprises at least colored particles.

16. The printing apparatus according to claim 3, further comprising a dust-removing member which removes dusts present on the surface of said printing medium at least one of before and during the printing onto said printing medium.

17. The printing apparatus according to claim 3, further comprising an opposing drum for mounting said printing medium disposed at a position facing said ejection head, said opposing drum being rotatable so as to move said printing medium to perform said image formation.

18. The printing apparatus according to claim 17, wherein said ejection head comprises a single channel head or a multi-channel head and is movable in a direction parallel to the axis of said opposing drum to perform said image formation.

19. The printing apparatus according to claim 3, further comprising at least a pair of capstan rollers for running said printing medium while being interposed and held therebetween upon said image formation.

20. The printing apparatus according to claim 19, wherein said ejection head comprises a single channel head or a multi-channel head and is movable in a direction orthogonal to the running direction of said printing medium to perform said image formation.

21. The printing apparatus according to claim 17 or 19, wherein said ejection head comprises a full line head having almost the same length as the width of said printing medium.

22. The printing apparatus according to claim 3, wherein said ink jet drawing device has an ink feed member which feeds said oil-based ink to said ejection head.

23. The printing apparatus according to claim 22, further comprising an ink recovery member which recovers said oil-based ink from said ejection head to circulate the ink.

24. The printing apparatus according to claim 3, wherein said ink jet drawing device has an ink tank for storing said oil-based ink and a stirring member which stirs the oil-based ink in said ink tank.

25. The printing apparatus according to claim 3, wherein said ink jet drawing device has an ink temperature-controlling member which controls the temperature of said oil-based ink in an ink tank for storing said oil-based ink.

26. The printing apparatus according to claim 3, wherein said ink jet drawing device has an ink concentration-controlling member which controls the concentration of said oil-based ink.

27. The printing apparatus according to claim 3, which comprises an ejection head-cleaning member.
